(19) United States
(12) Patent Application Publication
(10) Pub. No.: US 2014/0249903 A1
(43) Pub. Date: Sep. 4, 2014

(54) Non-contextual Information Collected and Transacted by Merchants and Consumers Thru POS and Mobiles

(71) Applicant: GERALD K. PRESTON, Grayson, GA (US)

(72) Inventor: GERALD K. PRESTON, Grayson, GA (US)

(21) Appl. No.: 14/083,449

(22) Filed: Nov. 19, 2013

Related U.S. Application Data
(60) Provisional application No. 61/727,865, filed on Nov. 19, 2012.

(51) Int. Cl. G06Q 30/02

(52) U.S. Cl. CPC G06Q 30/0222; G06Q 30/0238
USPC 705/14.22; 705/14.23; 707/802; 707/737

(57) ABSTRACT

This disclosure relates to a different system and methods which is offered to consumers and merchants. It describes the affordability it provide by reducing the numbers of touch points required for consumers to recognize a discount through the redemption of coupons. Along with a system accessible by merchants for entering products on coupons for savings to consumers. It details the critical components required for a seamless and transparent method to enter, view, select, collect, and redeem multiple coupon offers in a single scan or swipe of a mobile device.

### CROSS-REFERENCE TO RELATED APPLICATIONS

This application is a continuation of and claims priority under 35 U.S.C. §120 to U.S. Utility patent application Ser. No. 61/727,865, entitled “Non-contextual Information Collected and Transacted by Merchants and Consumers Thru POS and Mobiles,” having a filing date of Nov. 19, 2012, which is hereby incorporated by reference.

### BACKGROUND OF THE INVENTION

Consumers are primarily held to receive coupon offers through media via In-Store Handouts, In/On Pack & Cross-Ruffs, Magazines, Direct Mail, Newspapers, Prints from online downloads, and Uploads to Merchant's In-Store Saver or Loyalty cards. Consumers are required to carry numerous coupons for them to recognize savings or discounts. Consumers typically must carry clipped coupons in a bag, book, or a binder for entitlement. Other vehicles for redemption include In-Store Handouts, In and On Pack or Cross Ruffs, or to upload onto a Merchant and/or advertiser's In-Store Saver or Loyalty Card. The general problems that exist with these activities are that carrying multiple coupons is cumbersome and requires much work on the part of the consumer. After which the consumer performs the tasks used to carry coupons, most consumers have a high tendency to forget coupons at home, lose them, or have the coupons expire before use. Most coupons offered are limited and do not connect consumers to real-world products based on their preference. There is no way for consumers to inform merchants or manufacturers of the products they prefer to see as an offer or coupon. A further inconvenience is the time it takes the consumers to redeem the coupons at the point of purchase.

Most consumers either hand the coupon lot to the cashier to find and scan one-by-one or the consumers scan each coupon one by one her or himself. This can cause delays in the checkout process whenever one consumer has more than an amount of coupons that keeps the redemption process time higher than what is acceptable by a customer behind the consumer and merchant redeeming the coupons. In conjunction with these activities, Merchants are sometimes subject to marketing companies requesting upfront costs for campaigns that do not allow them to fully recognize quality high value deals or savings without a premium cost for the coupon campaign. Merchants dealing with alleged deep discount bargains or campaigns at times only realize small returns on the campaign agreement.

As a result, Merchants are at times reluctant to extend deep discounts through campaigns that require upfront absorbent costs that either do not provide the anticipated return on their investment or the customers do not execute the discount option due to the upfront cost associated with the offering. Some are configured to perform financial institutional transactions, while the intent of this invention is to only perform the actions needed to only deduct the coupon discount or savings amount from the item or items. While others are not fully automated, this system has specific attributes comprised within to allow full duplex interface between all components identified for full operability and use by consumers and merchants.

### SUMMARY OF THE INVENTION

The present invention comprising of a method and system for simultaneously redeeming a multitude of coupons through a plurality of data embedded within barcode symbologies. The webserver configured for use by Merchants, Manufacturers, and business entities to offer and collect specific through campaigns relating to products the offerer provides for discount to consumers. The database comprising of logic and algorithms used to differentiate the specificity of campaigns comprising of coupon offers wherein a plurality of products are identified that relate to the merchant, manufacturer, and business entities' industry.

The categories herein are a plurality of retail, hospitality, service selections that are, but not limited to Automotive, Beauty & Healthcare, Beauty Care, Computers and Technology, Department Store, Drugstores, Entertainment, Grocery Market, Hotels, Restaurants, and Super Stores; wherein each selection comprises of a named establishment identified as a participating coupon redemption location. An app comprising of the data provided by the merchants, manufacturers, and business entities having multiple coupon offers embedded within a barcode symbologies.

A coupon having a barcode symbologies configured for de-codification by a barcode reader paired with a point-of-sale system. The decoding of the barcode identifies a plurality of products or services selected by the consumer for discount during a purchase transaction. Scripts written for contiguous symmetry and appraisal of coupon transactional data between the database, mobile device, and server(s). A merchant server having a script loaded on the merchant client server side and used to maintain real-time updates to its records deemed for discount or savings to a consumer.

### BRIEF DESCRIPTION OF THE DRAWING

FIG. 1—Database comprising the information detailing the Merchant, Merchant Category, Participating Stores, Product Type, Coupon Offers, and Coupon Code Generator, Not all information required is shown.

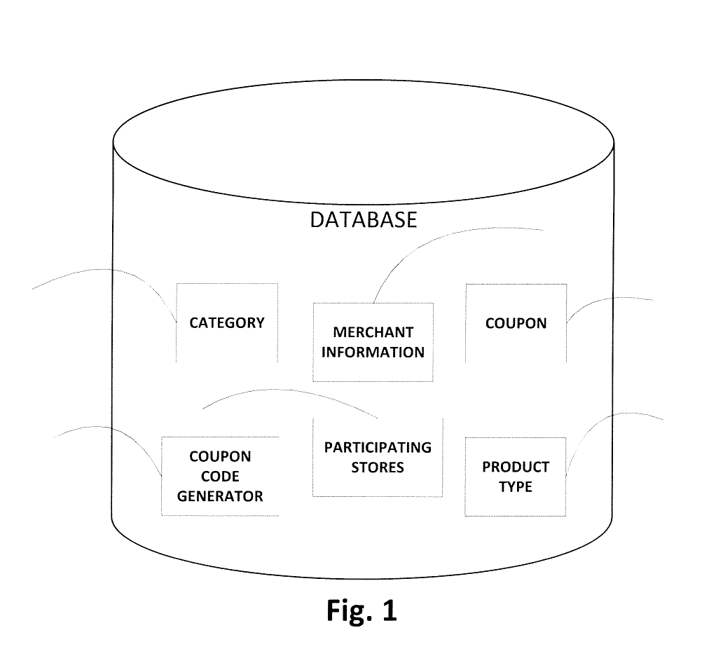

FIG. 2—A depiction of the Data Workflow attributes and how the input interacts with all components required for the functionality of the system and method to redeem multiple coupons.

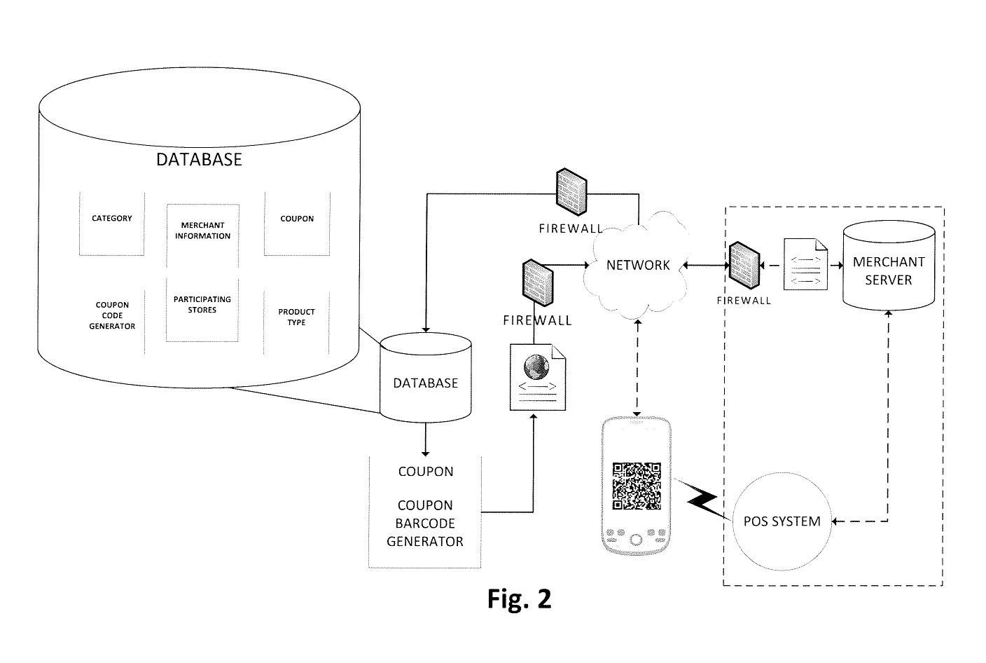

FIG. 3—Coupon layout view depicting the attributes that transfer data from the database to the mobile device for consumer review and selection.

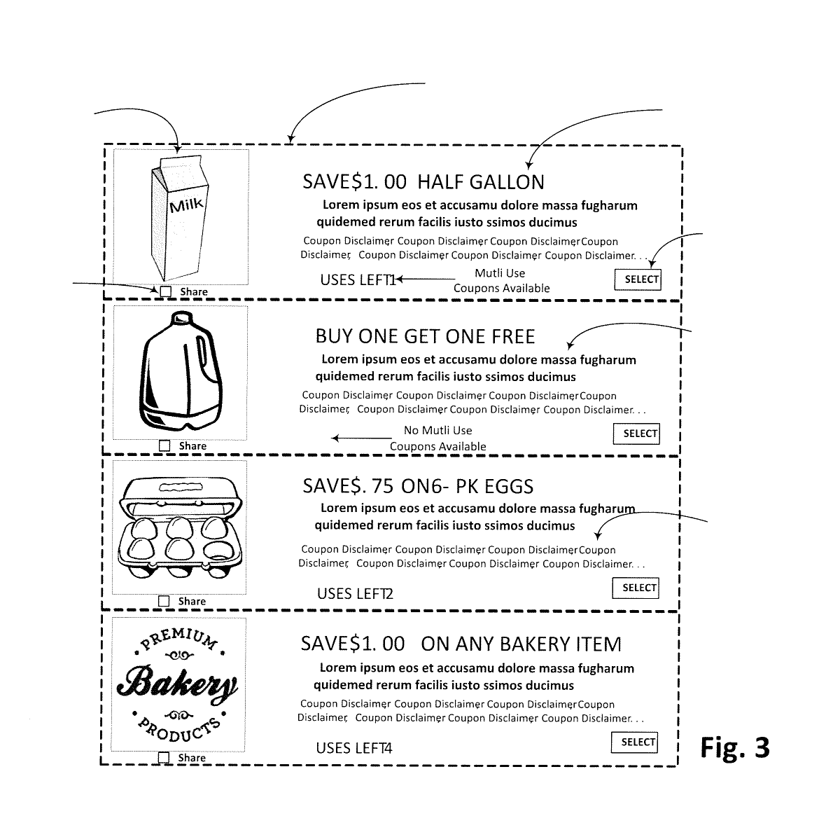

FIG. 4—Consumer Use Case describing the dataflow of the information from the database to the mobile device at the point where the consumer scans the barcode, POS decodes, consumers completes checkout, script validates, whereby the POS produces receipt showing items redeemed.

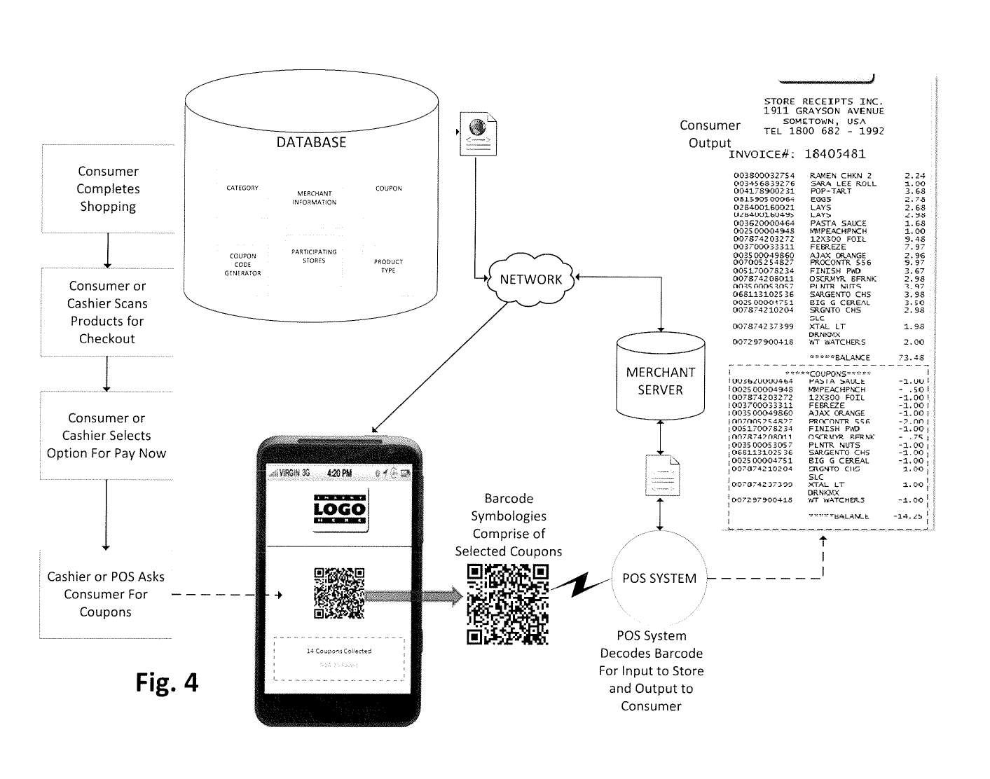

FIG. 5—Hi Level Diagram describing all the connecting components comprised within the system and method to redeem multiple coupons.

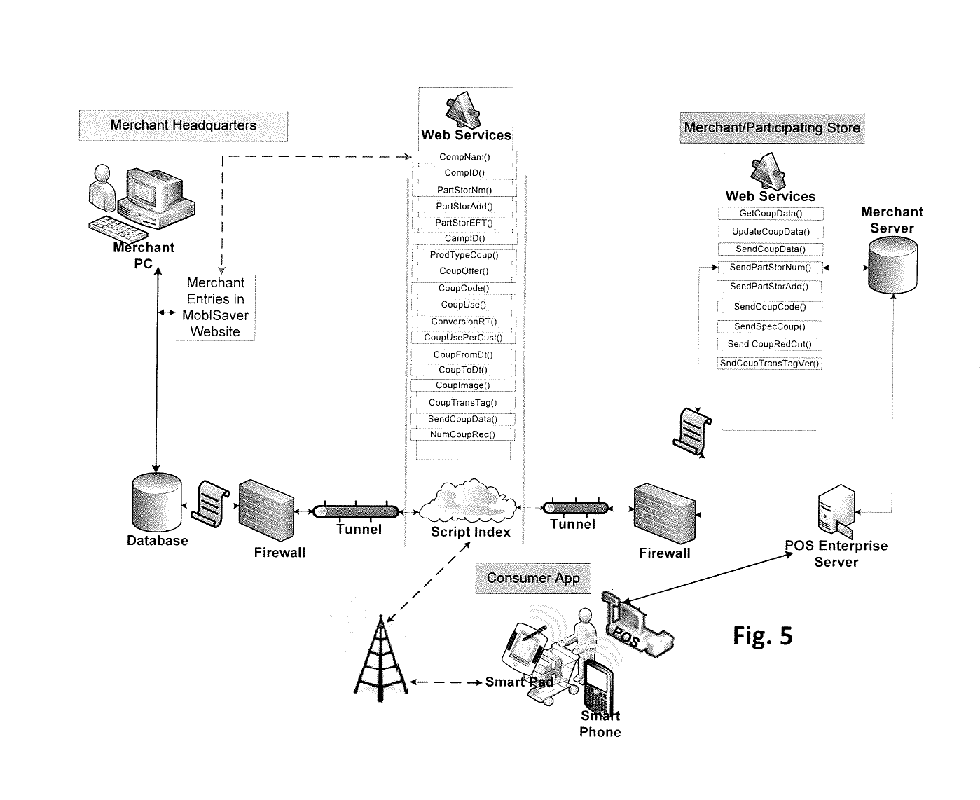

FIG. 6—Work Flow Diagram describing the interactions of the Merchants input (FIG. A) and the Consumer's actions (FIG. B) for real-time update to the merchant server (FIG. C) before and after coupon redemption.

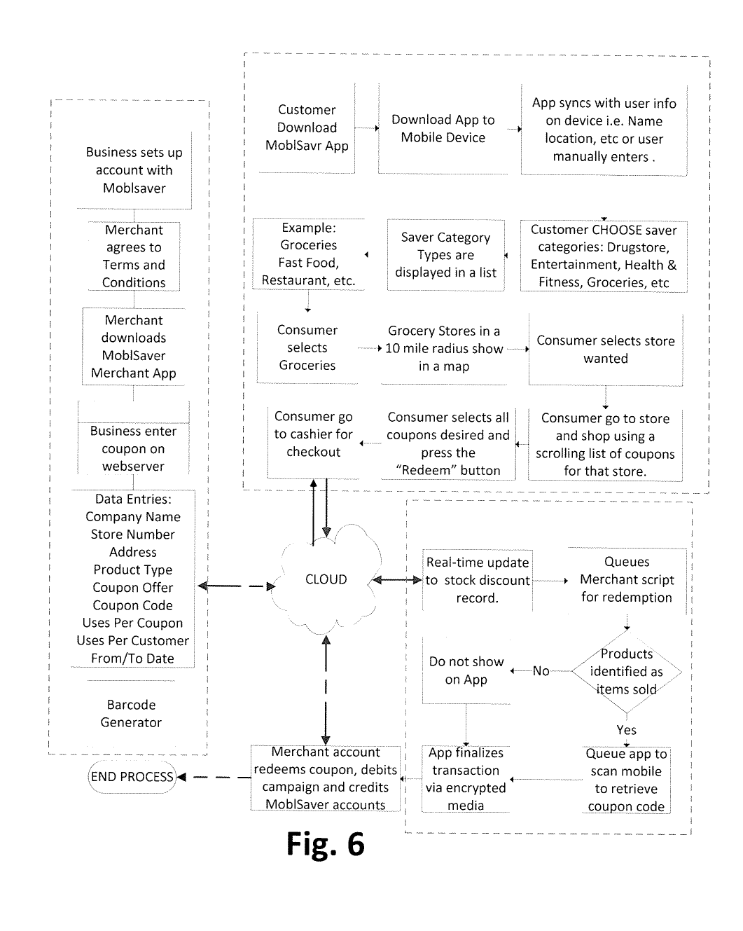

FIG. 7—Coupon Offer on mobile device (MoblSaver App) view and workflow of the consumer's actions required to redeem coupons.

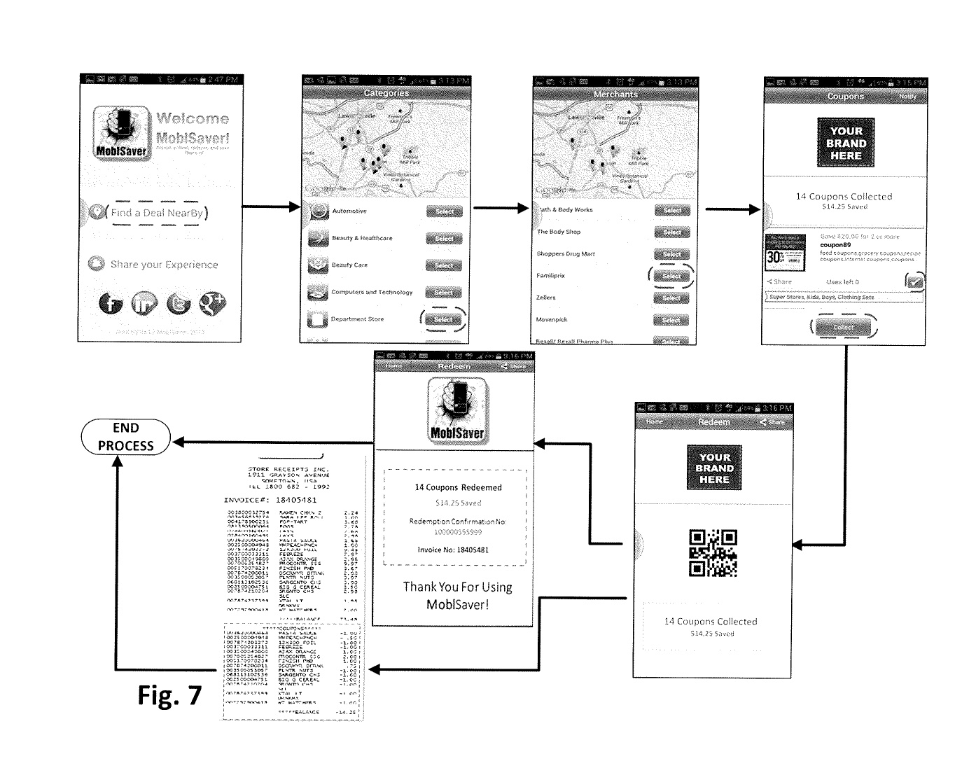

FIG. 8—App Interface Layout within database depicting the flow of data starting at the Merchant point of data entry to the consumers a mobile device.

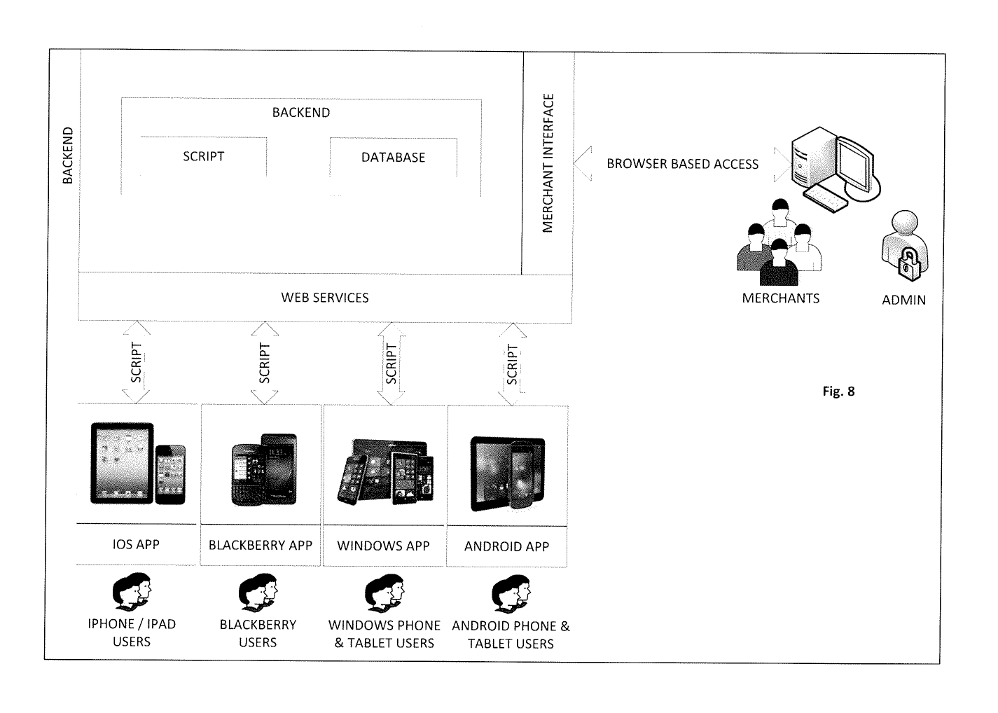

### DETAILED DESCRIPTION

Presently many inventions look at how inconvenienced consumers are when seeking ways to redeem coupons. In fact, although this is brought to light, the systems and methods suggested still do not afford consumers with the ability to recognize real saving through coupon mobility. At which, most indicate methods to incorporate technology only to give the consumer the burden of providing critical personal information online to incorporate coupons into a merchant POS system, others require the consumer to provide banking information to transact the coupon in the way ATM cards are used.

Some have files or a display of the coupon with the ability to scroll through a picture file of the coupon for redemption. Some require the consumer to have a ranking to determine the level of discount, and the merchant to have a product quality ranking that is acceptable within some unknown range to determine a best value coupon made available to the consumer. Many require the merchant to create the coupon online only to have the consumer print it for use at a brick-n-mortar location. The system and methods claimed in this invention has taken these critical points into consideration:

For Consumers—1. Are no longer restricted to retrieve coupons from 1. Websites comprising of coupons for download and printout. 2. Mobile devices that link to a website that comprise of singular coupons for single redemption at a POS system. 3. Customer accounts that require purchase of coupons for redemption. 4. A single coupon requiring the consumer to carry many coupons for a single transaction. 5. Can collect and redeem multiple coupon that are rendered in a single barcode symbologies. 6. Can transact all coupons collected under the single barcode symbologies in a single transaction. 7. No longer exposed to expired and dishonored coupons.

For Merchants—1. Are no longer restricted to pay upfront costs for coupon campaigns. 2. Distribution of coupons via paper. 3. Wait for second hand review and approval of coupons offered in a campaign. 4. No longer provide expired coupons. 5. Real-time consumer feedback on products.

What is claimed is:

1. A system used to redeem multiple coupons by consumers with a method comprising of:
a Database constructed with merchant informational logic comprised within an account associated with a category having product types that identify coupons offers for collection and redemption by consumers at participating stores, wherein:
a Coupon offer constructed with information by the merchant intended for exchange for discount by consumers when purchasing a product associated with the category the merchant has identified for use at a participating entity, wherein:
a Coupon code generator embedded having a logical relationship with the coupon offer and the mobile device to produce an optical machine-readable representation of the data of the coupon offer comprising of the product offered by the merchant, wherein:
a script written for the purpose of controlling the execution of the application through sets of logical sentences comprised within the database, mobile device, and transactional information within the domain on the client-side point-of-sale system and server, wherein:
a mobile device comprising of the coupon offers constructed with the products rendered by merchants intended for use by the consumer whereby the logic within the application residing on the mobile device produces a barcode symbologies, wherein:
a barcode symbologies comprising of encoded data related to a multitude of coupon offers selected by a consumer comprised of product type data identified for redemption through a barcode reader for a discount amount deducted from the original sell cost of an item, wherein:
a Point of Sale (POS) system calculating the difference of the redemption amount from the original sales cost of the item selected for purchase, wherein:
a merchant server comprising of the information specific to the items in the store for purchase to consumers and are identified for discount at the time purchase at the POS checkout location. The transaction data on the merchant server validates transaction against stock and the coupon offer within the campaign on the database by script for deduction and update to the offers in the merchant campaign.

2. A Database comprising of merchant, manufacturer, and business entity account data with an identification relating to a participating store, business category, product, campaign ID, product image, coupon offer, coupon code, number of uses per customer, a cost conversion rate associated with the coupon redemption, validity period, and the transactional ID associated with the product identified for discount.

3. A coupon offer comprising of a system allowing the method of viewing the offer product types in a scrollable list viewable for selection and collection by the consumer on the mobile device, where the coupon offer data is encoded within a barcode symbologies, set for transfer to a POS system by way of a barcode reading scanner that retrieves the information therein for deduction of the discount from the purchase item.

4. A coupon code generator comprising of data used to transfer coupon offer code to a barcode symbologies hat identifies the campaign comprised with the product comprising of the additional data required to validate the redemption at the point of sale checkout.

5. A script rendering on the database server comprising of procedures comprised of specific instructions detailing the category, the coupon offers, the product types, discount, the merchant store location, and the access to which consumers are able to redeem the coupon offer.

5. The data therein is communicated to the mobile device rendering a viewable barcode symbologies used to transact with a barcode reader that communicates with a POS system that processes the information to deduct the offer discount from the sale item, wherein the transaction data communicates with a client side script that transfers data to the merchant server comprising of stock information as it relates to the campaign offered by the merchant.

6. A mobile device rendering multiple merchant categories that comprise of a multitude of coupons based on the locality of the device; a merchant and manufacturer store location that is detected based on the locality of the store location to the device; a scrollable list of valid coupons offered by the merchant and manufacturer that is based on the merchant and manufacturer store location and is subject to showing coupons not expired; the option to choose the amount of coupons to be transacted based on the amount of coupons the merchant and manufacturer allows the consumer to use in one transaction; the option to select as many coupons needed by the consumer in one transaction; the option to make changes by deselecting a single coupon to decrease and increase the number of coupons that has multiple use for one device; the option to save changes made and cancel all options to maintain the original selected amount of coupons; a message that shows two options; the current status of coupons removed; a message for coupons to be redeemed; the option to further select more coupons to redeem the current coupon savings included; a viewable barcode symbologies comprising of a barcode with a plurality of encoded information embedded in the barcode symbologies; a barcode having a plurality of embedded barcode symbologies that transact multiple coupon discounts and back charges in a single swipe, a single scan, or reading in one transaction.

7. The mobile device rendering multiple merchant categories of claim 1, wherein the categories listed is pre-defined within the executable mobile application.

8. The mobile device comprising of multiple merchant and manufacturer store locations of the mobile device of claim 1, wherein the merchant and or manufacturer store location is entered in a server environment and is listed on the mobile device and rendered based on the locality of the mobile device and the store location address entered.

9. The mobile device rendering multiple merchant and manufacturer coupons of the device of claim 1, wherein; the mobile device comprises of merchant and manufacturer coupons information that is stored on a server and is provided directly from that server to the mobile device via the merchant and or manufacturer coupon offerer.

10. The mobile device rendering multiple coupons having a scrollable list of valid coupons of claim 1, wherein the coupon offer shall not be shown when the merchant and manufacturer location is not within the search distance specified by the mobile device nor if validity of the coupons shown on the mobile device when the end date expires; has passed causing the coupon to cease to exist.

11. The mobile device rendering the option to further select more coupons to redeem the current coupon savings listed of claim 1, wherein the option is prompted upon the action performed in claim 11 giving the consumer the ability to add more coupons as prescribed in claim 5; and the option to move to the redemption process as prescribed in claim 14.

12. The mobile device rendering the option to choose the amount of coupons to be collected, redeemed, transacted based on the amount of coupons the merchant and manufacturer allows the consumer to use in one transaction of claim 1, wherein the mobile device shows the amount of uses the device will transact against that particular coupon.

13. The mobile device rendering the option for a consumer to select as many coupons preferred by the consumer in one transaction of claim 1, wherein the selection process is based on the tap, click, and touch of the consumer to indicate the selection of the coupons by the consumer using the mobile device.

14. The mobile device rendering the option to make changes of claim 1, wherein the change making selection process is based on the tap, click, and touch indicating the selection to begin editing the amount of coupons not intended for use or the entire list of coupons previously selected.

15. The mobile device rendering the option to deselect one coupon; and decrease or increase the number of coupons that has multiple use for the consumer rendering using device of claim 1, wherein the deselection process of one coupon is based on the tap, click, and touch of the red-dash button indicating the deselection of the coupon.

16. The mobile device rendering the option to save and cancel changes made; the option to maintain the original selected amount of coupons of claim 1, wherein the tap, click, or touch of the save changes button saves the entries chosen by the consumer using the mobile device.

17. The mobile device rendering a viewable barcode symbologies comprising of a barcode having a plurality of barcode symbologies embedded of claim 1, wherein the barcodes comprise of encoded identifications embedded and associated with the input entered by the merchant and manufacturer offering the coupons entered in the secured server.

18. The viewable barcode symbologies comprising of barcode having a plurality of barcode symbologies embedded of claim 1; wherein the encoded information includes an algorithm that associates a specific value that interacts with a Point of Sale system's barcode reader comprising of the barcode symbologies giving the POS system the ability to retrieve the set amount of encoded information to perform deductions from the product amount prescribed for discount within the sale of the purchase item.

19. A POS system rendering he encoded information embedded having an algorithm that performs interface within the POS system that executes the deductions, discounts, and charge-backs against the items selected in the inventory as a coupon item, candidate, or entrant selected for the redemption in the given transaction; wherein the option is prompted upon the action performed in claims 1, 13, and 14.

20. An input data string encoded is batched; having specific values divided into groups comprising of a series of commands intended to execute through the barcode symbologies relative to the barcode scanner used to decode the specific values the POS system use to translates multiple coupon offers redeemed at the point of purchase.

21. The viewable transaction performed includes the encoded information executed by the POS that uses the interface algorithm logic during the transaction for the coupon item, candidate, and entrant selected for the redemption in the given transaction of claim 14; wherein the POS system's viewable cashier screen shows the deductions, discounts, and charge-backs against the items selected for redemption within the sale transaction.

22. The merchant server of claim 1, wherein comprise of the attributes specifics to the components having the coded related to the values for the a coupon offer to maintain real-time updated information that allows a consumer to effectively redeem multiple coupons for discount at a retail and service provider location and ready for transaction at the time which the consumer uses to request the savings.
